(19) United States
(12) Patent Application Publication
(10) Pub. No.: US 2023/0033457 A1
(43) Pub. Date: Feb. 2, 2023

(54) ADJUSTABLE CAMERA UNIT ON LAPTOP COMPUTER

(71) Applicant: SAM W. HAN, MARTINEZ, CA (US)

(72) Inventor: SAM W. HAN, MARTINEZ, CA (US)

(21) Appl. No.: 17/300,317

(22) Filed: Nov. 18, 2020

(51) Int. Cl. G06F 1/16; H04N 5/225

(52) U.S. Cl. CPC G06F 1/1686; H04N 5/2257

(57) ABSTRACT

For common Laptop Computer or Notebook Computer, this present invention enables the Monitor Screen part of the computer body adjustable in height but remain attached to the rest of the computer body which usually includes keyboard. This present invention will limit it's Claim applicable only to Laptop or Notebook Computers, not to Desktop Computers nor Mobile Phones. It is common these days, that Laptop or Notebook Computers have pre-installed camera on top center of the monitor screen.

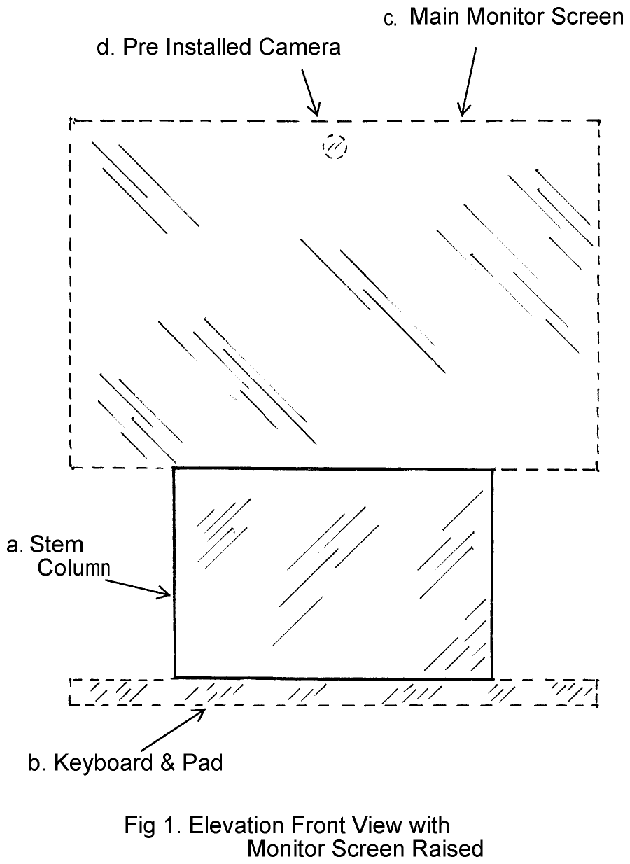

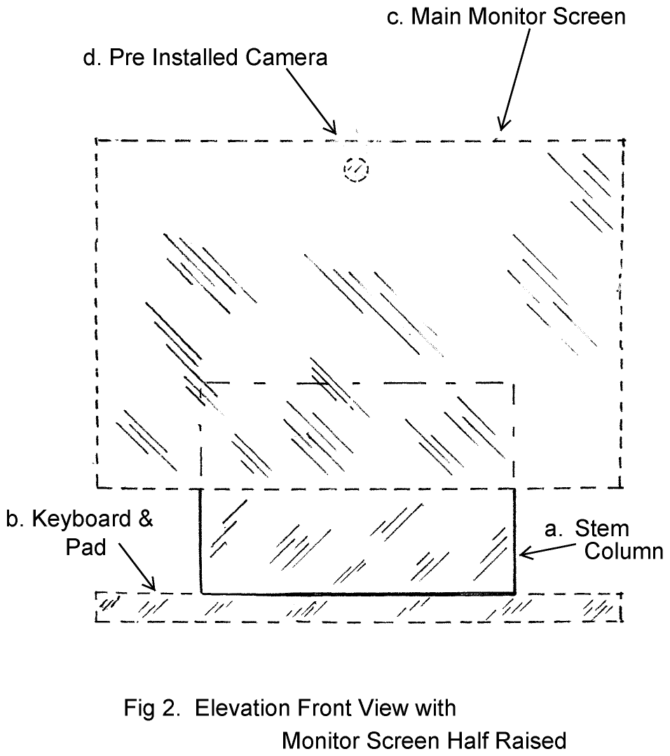

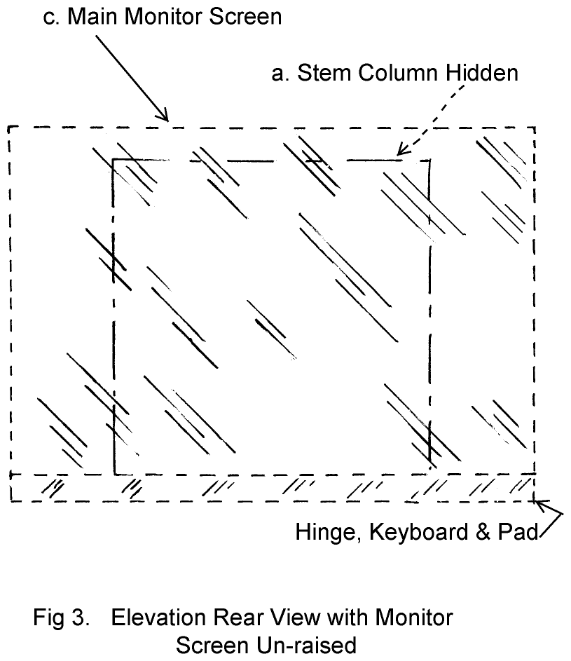

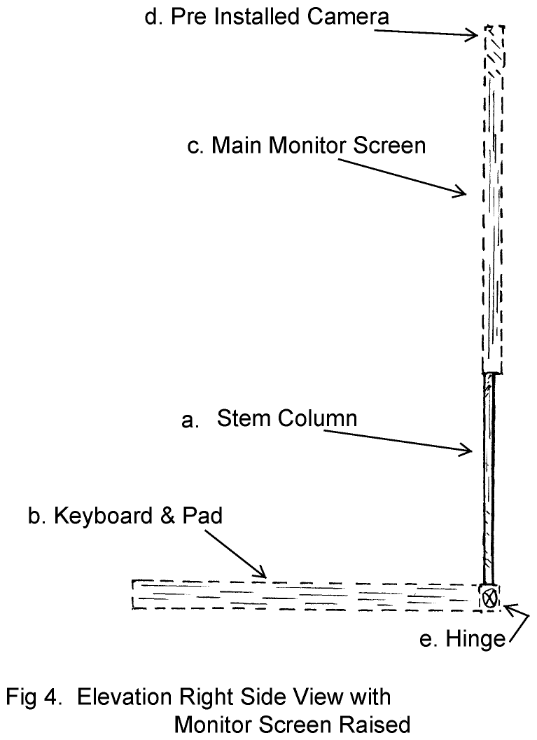

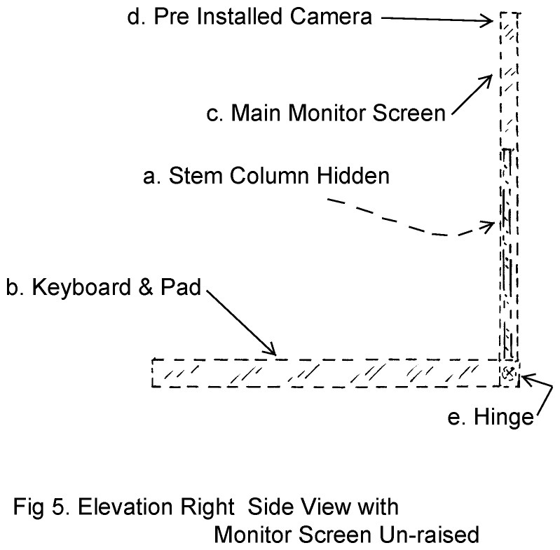

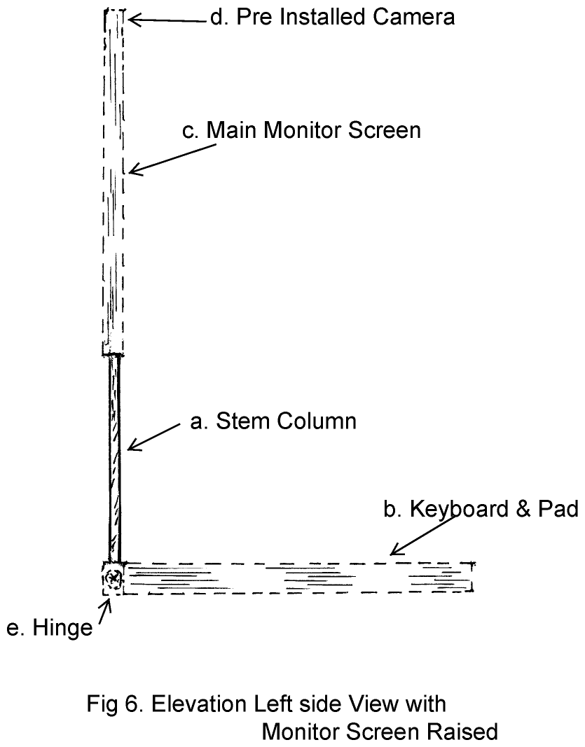

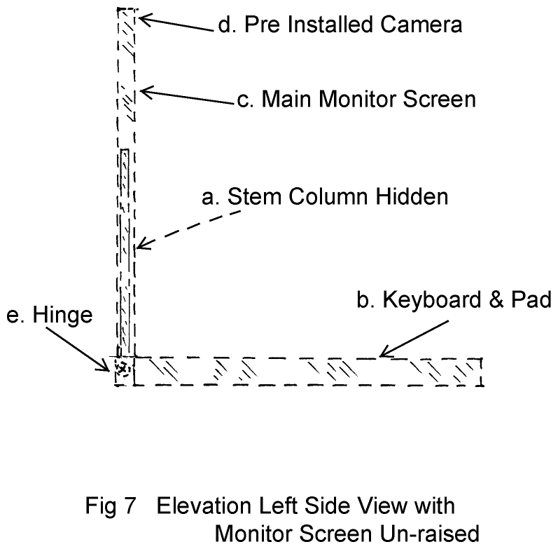

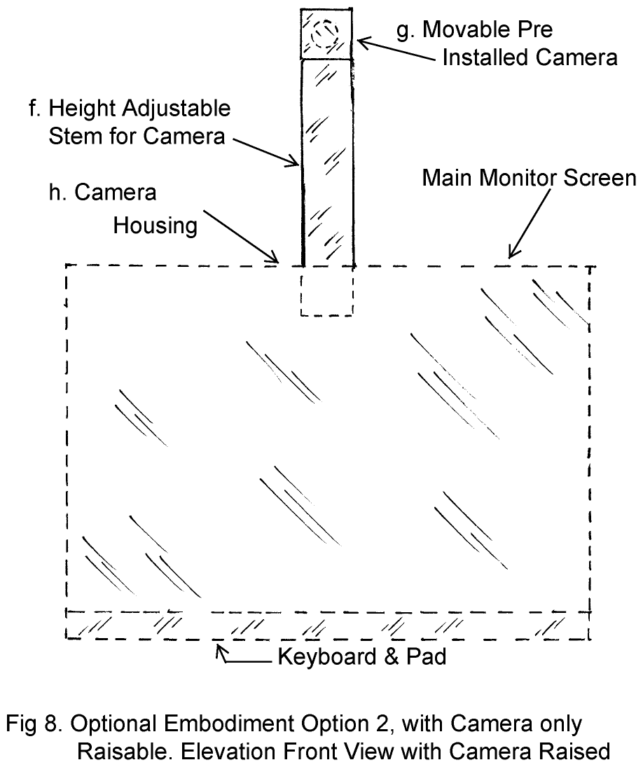

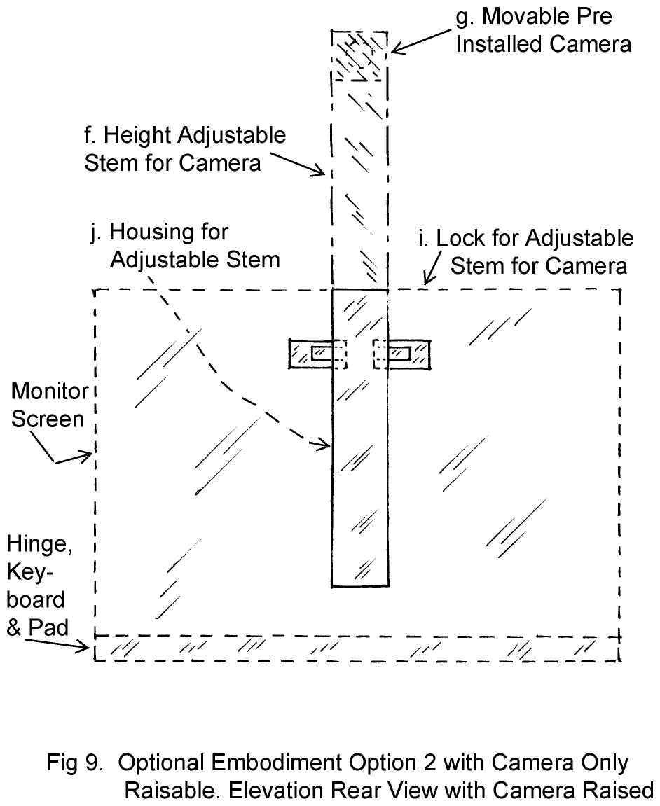

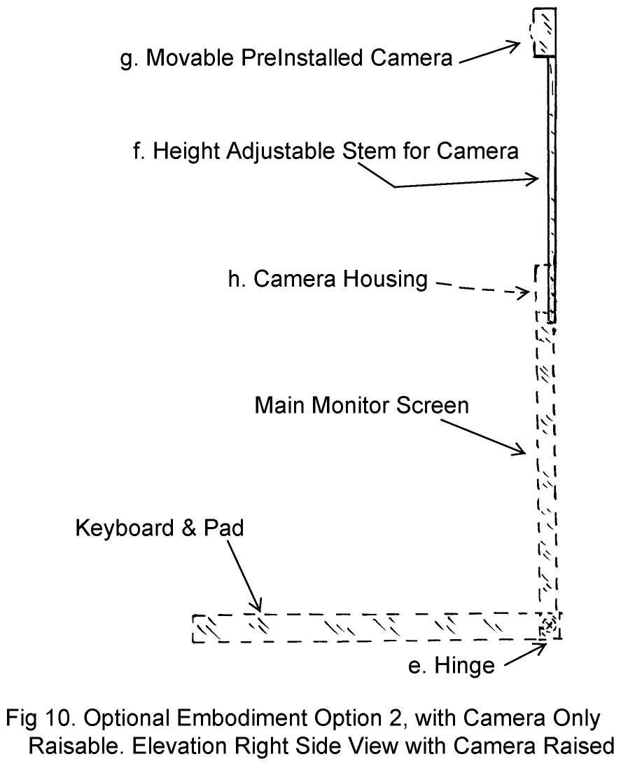

This present invention enables the user to bring the pre-installed camera to the eye level, capturing more desirable eye level angle of the user-presenter in online communication.

This present invention, enables Laptop Computer or Notebook Computer to have an Adjustable Monitor Screen Height or Adjustable Height of Pre-installed Camera Unit.

This present invention will limit it's Claim applicable only to Laptop Computers and Notebook Computers, not Desktop Computers which usually have separate monitor screen, separate Keyboard, and separate Main Computer body.

The benefit of this present invention is that the usual Pre-installed Camera on Laptop or Notebook Computer could be at the Eye level of the user. Before this present invention, the user's eye level is much higher than the Elevation of the Pre-installed Camera of Laptop or Notebook Computers, when user placed the Laptop or Notebook computer on usual table or desks. When the camera elevation is much lower than the eye level of the user, the camera captures the user's face from much lower angle showing upwards view of user's face. Thus it does not transmit or communicate the more desirable eye level angle picture of the Presenter. This is rather well known limit of current available Laptop or Notebook Computers with Pre-installed Camera.

Some users place a few thick books to raise the elevation of the Laptop or Notebook Computer that the Pre-installed Computer Camera can capture the user's eye level angle. Also, there are external apparatuses or devices which could elevate the Laptop or Notebook Computers. However, many consumers may not even know such external devices are available in the market. And most of those after market devices, raise Keyboard elevation at the same time, which could be inconvenient.

This present Invention will make it much more convenient for consumers, enabling the Laptop or Notebook Computers to have Height adjustable Monitor Screen or Height adjustable Camera Unit while Keyboard stays flat on the surface. And consumers do not need to carry additional external apparatus.

As online communication, including Video and Audio communication, becomes more common activity in daily Life, Business, or Education, etc. many users could appreciate the enhancement with this present invention. The Video or Photograph captured and used for online communication, would have more appropriate eye level picture presented to the Audience.

This present invention will limit it's Claim applicable only to Laptop or Notebook Computers, as stated above.

This present invention could have two possible embodiment options, and whichever the manufacturing companies prefer, they may choose.

One preferred embodiment is to make the whole monitor screen adjustable in Height as to have the usual Center top Camera elevation is adjusted along with the monitor screen.

Second less preferred embodiment is to have only the Camera Unit adjustable in Height. I, the inventor reason, the second option of embodiment would be disadvantageous because, when the user communicates looking at elevation raised Camera on Laptop or Notebook Computer, the user will be fine with his or her eye level captured and presented properly to the audience, but when the user becomes the audience while the other party presents, the first user mentioned, will look down on monitor screen to view the screen as the other party presents. It is because the Camera elevation has been raised when monitor screen has not.

But, if manufacturer is OK, with that, they may choose embodiment of second option. But, as mentioned above, I, the inventor reason the embodiment of first option be better option for functionality. With first embodiment option, as elevation of monitor and camera are raised together, the user will have much less variance of eye level, either when the user presents or when the user is the audience looking at the monitor screen.

However, at any situations above, the Monitor Screen and Camera Unit will remain electronically and physically, connected to the main computer body which usually includes Keyboard. The benefit will be tremendous, enabling the users present their face in online communication, with much more desirable eye level angle, without any external devices or thick books under the Laptop or Notebook computers.

This present invention claims as follows.

1. It claims the new Structure of commonly called Laptop Computer or Notebook Computer, to allow the Height Adjustment of the attached monitor screen or commonly pre-installed camera unit. The monitor screen or camera unit will remain connected to the rest of the computer body, by the Extension Stem or Connector.
By doing so, the present invention abler the user to have the camera or monitor at user's eye level or closer to eye level, without external apparatus.
The claims on this present invention limit itself only applicable to Laptop Computers or Notebook Computers of which the monitor screen and the computer body is one, uni-body construction commonly, not applicable to Desktop Computers which usually have monitor, keyboard, mouse, computer unit separate. With this new present invention, when the monitor screen, on commonly called Laptop Computers or Notebook Computers, are raised in height with a stem, stems, or column, supporting and holding the monitor as in drawings, the commonly pre-installed center top camera unit will be raised in height together with the monitor screen.

2. Also, this present invention claims optional embodiment, as to only the pre-installed camera unit be movable in height while monitor screen is not moved. In this second option, the pre-installed camera unit can be pulled out and adjusted to a desired height.
In either embodiment as in claim 1, above or in claim 2 here, the benefit of adjustable camera height is achieved.

3. This present invention claims the new structure of Laptop or Notebook computers to have monitor screen or pre-installed camera unit adjustable in height. It's purpose is to have the usual center top camera at the same, or similar to the Eye level, of the user. When the user presents in online communication, this present invention will help the user to present the better angle of the user's face with camera capturing more desirable eye level picture.

4. The present invention claims as above, it is designed to allow the monitor screen or camera unit movable in height. The extension stem will be integral part of the body of whole Laptop or Notebook Computer as discussed above and as it can be seen in the drawings. For embodiment where whole monitor together with pre-installed camera is adjustable supported and connected by the Extension Stem, the Stem should be integral part of the monitor screen and also, connected to the lower computer body with keyboard on.
As the Extension Stem supports the movable monitor screen, at what depth in the monitor screen unit, the Extension or Connecting Stem is placed, will be left to manufacturers to decide. Also, how the Extension is wired within the Stem will be left for manufacturers to decide. For example, the connecting Stem could be placed right behind the monitor screen or it could be placed at outer body of the monitor unit.
